(19) United States
(12) Patent Application Publication
(10) Pub. No.: US 2006/0238815 A1
(43) Pub. Date: Oct. 26, 2006

(54) Systems and methods of reproducing images onto surfaces

(75) Inventor: Jeffrey E. Polus, Hillsboro, IL (US)

Correspondence Address: LEE & HAYES, PLLC, 421 W. RIVERSIDE AVE., SUITE 500, SPOKANE, WA, 99201, US

(73) Assignee: The Boeing Company, Chicago, IL (US)

(21) Appl. No.: 11/112,698

(22) Filed: Apr. 21, 2005

(51) Int. Cl. H04N 1/40; H04N 1/00

(52) U.S. Cl. 358/3.24; 358/401; 358/2.1

(57) ABSTRACT

Systems and methods of reproducing images onto surfaces are disclosed. In one embodiment, the system includes an image file that digitally produces a planar surface normal to a surface of a master model. The planar surfaces are referenced to a coordinate system of the master model through a series of points. A tracker surfacing system, comprising a tracking instrument, generates and emits a signal as the tracking instrument crosses the planar surface. Finally, an output device is actuated by the tracking device as it crosses the planar surface, reproducing the series of points as an image onto a surface, including a flat, curved or compound surface. The images may include lines, cross hairs and text.

### FIELD OF THE INVENTION

This invention generally relates to systems that reproduce images, and more specifically, to systems that reproduce images onto surfaces, including compound.

### BACKGROUND OF THE INVENTION

Complex surfaces, including small components such as mechanical parts or large objects such as buildings, have traditionally been mapped using standard methods, including mylar transfer templates, theodolites laser trackers, and more recently, laser projectors. Generally, these methods are time consuming, tedious and may lack accuracy. For example, a laser projector may be used to project two-dimensional images onto a contoured surface. The projected images are used as patterns for manufacturing products and locating an image onto a desired location. For example, an image may be projected onto a ply manufactured for airplane fuselages, and the like. To be effective, the laser emmiter must generally be positioned in an accurate and precise manner. The projector's designated points and angles, however, may not be accurately controlled. The larger the image required to be projected and the more complex the surface is to be projected upon, it becomes necessary to use multiple laser projector heads to accurately project the lines in their proper location. In addition, the focal length of the laser may be hindered by physical objects, i.e. floors, walls, support posts, & ceilings. If the projection head can not be placed far enough away from the object, it will be unable to project over the entire surface thus requiring more equipment or additional set-ups.

Recently, theodolites have been employed to provide for greater accuracy in determining the coordinates of the reference marks. A Theodolites is a mounted optical instrument, which measures horizontal and vertical angles in space. Though it may accurately define a point from the horizontal and vertical angles of a surface relative to a given coordinate system, it typically does not indicate the object geometry, including shape, dimension, and location. Generally, a theodolite is fairly expensive, time consuming and labor intensive. Moreover, current methods of mapping complex surfaces lack the ability to print images onto complex contoured surfaces that have no physical points of reference.

### SUMMARY

The present invention is directed to systems and methods of reproducing images onto surfaces. Embodiments of the present invention generally provide a method of outputing images, including lines, cross hairs and text, onto complex surfaces, including complex contoured surfaces. Embodiments of the invention may thus be applied to aeronautical, automotive and marine parts and systems, as well as in a field of graphical arts such as signs, bill boards, stadium grounds, landscaping lay-out, or any surface that can be digitally rendered or reproduced within a CAD program and other suitable applications.

In one embodiment, a system for reproducing images onto surfaces includes an image file that digitally produces a planar surface normal to a surface of a master model (or digitally surfaced model). The planar surface is referenced in a coordinate system of the master model through a series of unique points that are coordinated between the actual part & the digital model. The actual points are imported into the digital model and a best fit between the two sets of reference points is determined. A tracker surfacing system tracks the series of points. The tracker surfacing system comprises a design program and a tracking instrument, the design program adapted to generate and emit a signal as the tracking instrument crosses the planar surface. Finally, an output device coupled to and actuated by the tracking instrument reproduces the series of points as an image onto a surface.

### BRIEF DESCRIPTION OF THE DRAWINGS

Preferred and alternate embodiments of the present invention are described in detail below with reference to the following drawings.

FIG. 1 is a schematic view of the system for reproducing images onto surfaces, according to one embodiment of the invention;

FIG. 2 is a schematic view of the system for reproducing images onto surfaces, according to another embodiment of the invention;

FIG. 3 is a schematic view of a system for reproducing images onto surfaces, according to yet another embodiment of the invention;

FIG. 4 is a block diagrammatic view of a method of reproducing images onto surfaces, according to an embodiment of the invention;

FIG. 5 is a block diagrammatic view of a method of reproducing images onto surfaces according to yet another embodiment of the invention; and

FIG. 6 is a side cross-sectional view of a tracking instrument in accordance with an embodiment of the invention.

### DETAILED DESCRIPTION

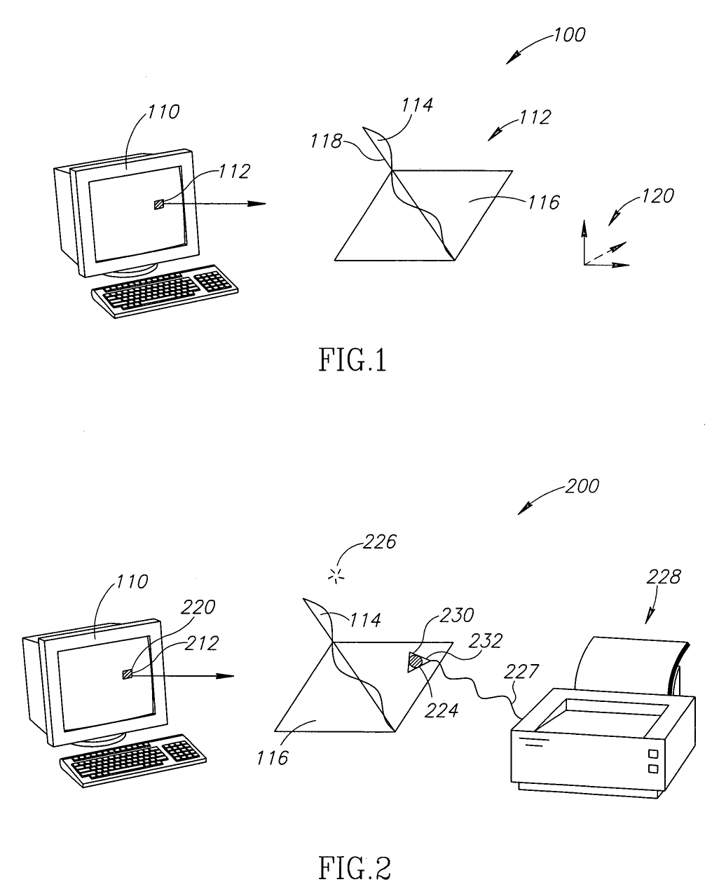

The present invention relates to systems and methods for reproducing images onto surfaces. Many specific details of certain embodiments of the invention are set forth in the following description and in FIGS. 1-6 to provide a thorough understanding of such embodiments. One skilled in the art, however, will understand that the present invention may have additional embodiments, or that the present invention may be practiced without one or more of the details described in the following description.

In general, embodiments of methods and systems in accordance with the present invention may be used for reproducing images onto a variety of surfaces. The surfaces may include relatively simple contoured surfaces, or compound contoured surfaces, including surfaces encountered in aeronautical, automotive, and marine applications. In further embodiments, the surfaces may include relatively flat surfaces, including, for example, signs, billboards, and any other suitable surfaces.

FIG. 1 is a schematic view of a system for reproducing images onto surfaces 100, including compound contoured surfaces. The system may include an operating interface 110 comprising a computer, such as a desktop, laptop, or any other suitable interface device. The operating interface 110 may be used to produce and store an image file 112. In one embodiment, the image file 112 may comprise a digitally produced .igs (image grayscale system) file, or other suitable digital file. An .igs file may display a full range of black and white images, including various shades of gray. The image file 112 may then be adapted to digitally produce a planar surface 114 normal to a surface of a master model by extruding the line created from the intersection of the edge of a modeled part and the digital master model surface 116. The planar surface 114 may be extruded from the surface of a master model 116, such as a mechanical part like an aircraft stiffener, for example, to a plane 118 normal to the outer mold of the master model. The resulting extruded planar surface 114 may be referred to as a “fence file”. The extruded planar surface (i.e. fence file) 114 may appear to look like a ribbon, following the contours of the master model 116 created by extruding the lines normal to the surface of the master model 116. These surfaces 114 may be referenced to a coordinate system 120 of the master model 116 through a series of points (not shown). In one particular embodiment, the coordinate system 120 may comprise a Cartesian coordinate system. In alternate embodiments, the coordinate system 120 may include a two-intersecting planar system, a three-intersecting planar system, or any other suitable coordinate system.

FIG. 2 is a schematic view of another embodiment of the present invention. In addition to producing and storing the image file 112, the operating interface 110 may comprise a tracker surfacing system 220, which includes a design program 222. In one embodiment, the design program 222 includes a computer aided design program (CAD) that can model surfaces via a computer. The CAD program may, for example, be a commercially-available program, including the Unigraphics® program available from Electronic Data Systems Corporation of Plano, Tex., the CATIA® program available from Dassault Systemes Corporation of Suresnes, France, or any other suitable CAD program. The CAD program may be adapted to convert the “blueprint” drawings to create two-dimensional (2-D) drawings or three-dimensional (3-D) models. The design program 222 may further includes a Computer-Aided Inspection Program 223, including, for example, the VERISURF® Computer Aided Inspection Program commercially-available from Verisurf Software, Inc. of Anaheim, Calif. The Computer Aided Inspection Program 223 compares actual readings from an actual device to theoretical designed model surfaces.

Still referring to FIG. 2, the tracker surfacing system 220 also includes a tracking instrument 224. The design program 222 may be adapted to generate and emit a signal 226 as the tracking instrument 224 crosses the extruded plane (or fence file) 114. In one particular embodiment, the tracking instrument 224 includes a tracker ball and uses software that samples how close the center (0,0,0) of the tracker ball is to the extruded fence file 114. As the center of the ball crosses the extruded plane 114, the tracking instrument 224 emits an electrical signal. In one embodiment, the signal 226 may be transmitted via a cable 227 to an output device 228. In another embodiment, the signal 226 may be transmitted via electromagnetic waves, acoustic signals, optical signals, or any other suitable means. In operation, the crossing of the tracking instrument 224 over the planar surface 114 may actuate the output device 228. More specifically, in one particular embodiment, the output device 228 may include an ink jet printer, and the tracking instrument 224 may emits an electrical signal that triggers the ink jet to fire. If necessary, the ink jet can be set to fire numerous shots in quick succession. The output device 228 may be used to reproduce the series of points of the master model 116 onto a surface (not shown). The output device 228 may include a printer, scanner, facsimile, laser, electron beam, computer display, and other suitable device.

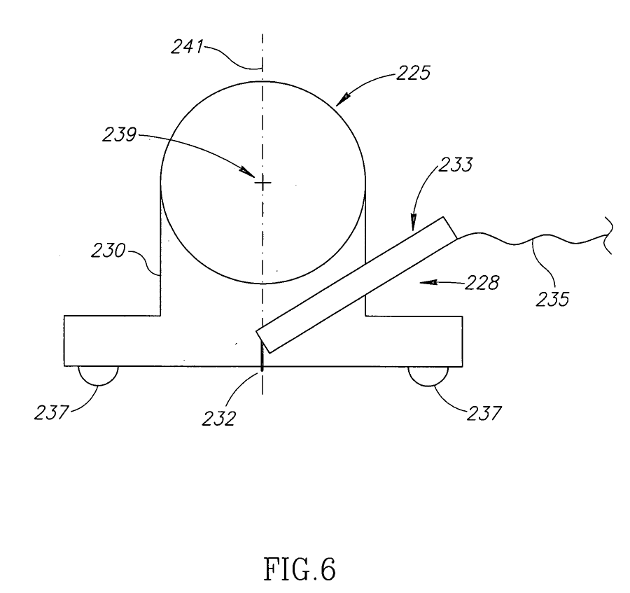

In an alternate embodiment, the output device 228 may be mechanically coupled to the tracking instrument 224. For example, FIG. 6 is a side cross-sectional view of a tracking instrument 224 in accordance with an embodiment of the invention. In this embodiment, the tracking instrument 224 includes a housing member 230 that operatively supports a tracking ball 225 and an output device 228. In alternate embodiments, the tracking instrument 224 may include a laser tracking ball, a laser tracker projector, or any other suitable tracker surfacing instruments. The output device 228 includes an ink jet head 232 coupled to an ink reservoir 233. A power lead 235 provide power to the output device 228, and feet (or rollers) 237 support the housing 230. As further shown in FIG. 6, a center point 239 of the tracking ball 225 is aligned with the ink jet head 232 along a tracking axis 241.

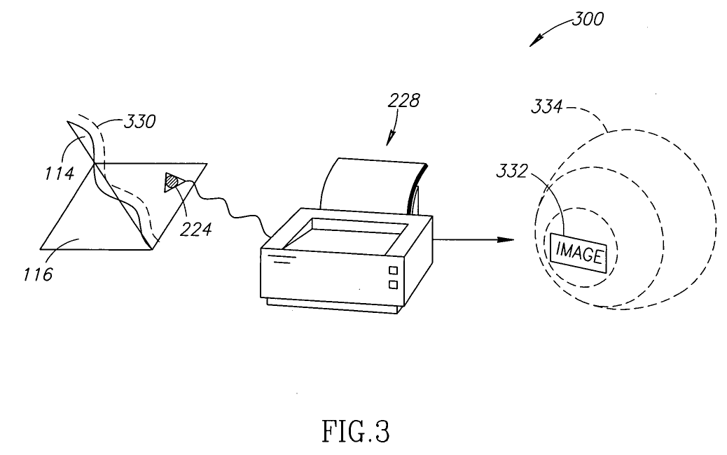

Now referring to FIG. 3, a tracking instrument 224 may track the extruded plane 114, as previously described with reference to FIG. 2. As the tracking instrument 224 tracks the planar surface 114, the tracking instrument 224 may actuate the output device 228 to reproduce the series of points 330 of the master model. In one particular embodiment, as the tracking instrument 224 is passed over the planar surface 114 at different locations, a point 330 may be produced at each intersection (not shown). The series of points 330 may then be reproduced as an image 332 onto a surface 334, including onto a flat, curved, or compound surface.

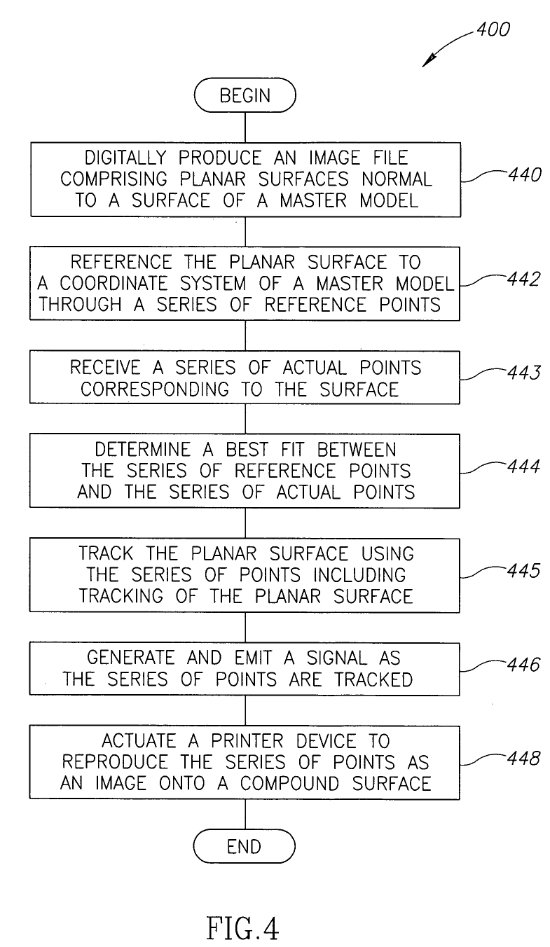

FIG. 4 is a block diagrammatic view of a method of reproducing images onto surfaces. At a block 440, an image file comprising planar surfaces normal to a surface of a master model is digitally produced. The image file may be digitally produced by an interface operator 110, as previously described with reference to FIG. 1. The master model may then be referenced, at a block 442, in a coordinate system through a series of reference points that are coordinated between the actual part and the digital model. At a block 443, the actual points are imported into the digital model, and at a block 444, a best fit between the two sets of reference points is determined. At a block 445, the series of reference points may be used to track the planar surface extruded from the master model. A tracking instrument, as previously described with reference to FIG. 2 and FIG. 3, may be employed to track the planar surface. As the series of reference points are tracked, a signal may be generated and emitted at a block 446 by a design program, such as a CAD program. An output device (e.g. a printer) is actuated, at a block 448, by the tracking instrument to reproduce the series of reference points as an image onto a surface. In particular embodiments of the present invention, the surfaces may include contoured surfaces and compound contoured surfaces, including aeronautical, automotive, and marine surfaces. In alternate embodiments, the surfaces may include relatively flat surfaces, including, for example, signs, billboards, stadium grounds art and layouts, and any other suitable applications.

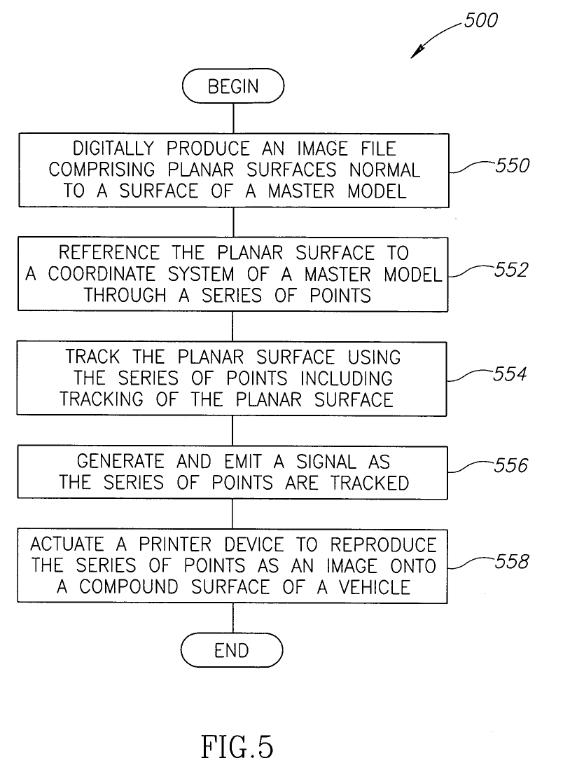

FIG. 5 is a block diagrammatic view of a method of reproducing images onto surfaces, according to another embodiment of the present invention. At a block 550, an image file comprising planar surfaces normal to a surface of a master model is digitally produced. The master model may then be referenced, at a block 552, in a coordinate system through a series of points. At a block 554, the series of points may be used to track the planar surface extruded from the master model. A tracking instrument, as previously described with reference to FIG. 2 and FIG. 3, may be employed to track the planar surface. As the series of points are tracked, a signal may be generated and emitted at a block 556 by a design program, such as a CAD program. An output device is actuated, at a block 558, by the tracking device to provide an image onto a surface, such as a surface of a vehicle. In alternate embodiments, as described above with respect to the method 400 shown in FIG. 4, a series of actual points may be imported into the digital model (block 443), and a best fit between the two sets of points may be determined (block 444).

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A system for reproducing images onto surfaces, comprising:
an image file adapted to digitally produce a planar surface normal to a surface of a master model, the planar surface referenced in a coordinate system of the master model comprised of a series of points;
a tracker surfacing system comprising a design program and a tracking instrument, the design program adapted to generate and emit a signal as the tracking instrument crosses the planar surface; and
an output device coupled to the tracking instrument, the output device actuated by the tracking instrument to reproduce the series of points as images onto surfaces.

2. The system in claim 1, wherein the image file comprises an image grayscale system file.

3. The system in claim 1, wherein the master model comprises a mechanical part, including at least one of an aircraft, automotive or marine mechanical part.

4. The system in claim 1, wherein the master model comprises a graphical layout, including at least one of a sign, billboard and grounds art.

5. The system in claim 1, wherein the coordinate system comprises a planar coordinate system, including at least one of a two-intersecting planes and a three-intersecting planes coordinate system.

6. The system in claim 1, wherein the design program comprises a computer aided design program, including at least one of an architectural design program, an electronics design program, a roadway design program, and a woven fabric design program.

7. The system in claim 5, wherein the signal comprises at least one of an electrical signal, an electromagnetic wave, an acoustic wave, and an optical signal.

8. The system in claim 1, wherein the tracking instrument comprises at least one of a laser tracking ball and a laser tracking projector, the tracking instrument further adapted to actuate the output device as it crosses the planar surface.

9. The system in claim 1, wherein the output device comprises a housing member detachably coupled to the output device, the housing member adapted to house the tracking instrument.

10. A method of reproducing images onto surfaces, comprising:
digitally producing an image file comprising planar surfaces normal to a surface of a master model;
referencing the planar surface to a coordinate system of the master model through a series of reference points;
tracking the planar surface using the series of reference points;
generating and emitting a signal as the series of reference points are being tracked; and
actuating an output device to reproduce the series of reference points as an image onto a surface.

11. The method of claim 10, further comprising:
receiving a series of actual points corresponding to the surface; and
determining a best fit between the series of reference points and the series of actual points.

12. The method of claim 10, wherein digitally producing an image file includes producing an image grayscale system file.

13. The method of claim 10, wherein digitally producing an image file comprising planar surfaces normal to a surface of a master model includes master models of at least one of a mechanical part and graphics layout.

14. The method of claim 10, wherein referencing to a coordinate system includes referencing to a planar coordinate system, further including at least one of a two-intersecting plane and a three-intersection planar coordinate system.

15. The method of claim 10, wherein tracking the planar surface includes tracking using a tracking surfacing system, further including a computer aided design program.

16. The method of claim 10, wherein generating and emitting a signal includes generating and emitting at least one of an electrical signal, an electromagnetic wave, an acoustic wave, and an optical signal.

17. The method of claim 10, wherein actuating an output device includes actuating an output device by the tracking instrument as it crosses the planar surface.

18. The method of claim 10, wherein reproducing the series of reference points includes reproducing at least one of lines, cross hairs and text.

19. A method of reproducing an image onto a surface of a vehicle, comprising:
digitally producing an image file comprising planar surfaces normal to a surface of a master model;
referencing the planar surface to a coordinate system of the master model through a series of reference points;
tracking the planar surface using the series of reference points, including tracking the planar surface using the series of reference points;
generating and emitting a signal as the series of reference points are being tracked; and
actuating an output device to reproduce the series of reference points as an image onto a surface.

20. The method of claim 19, wherein reproducing images onto a surface of a vehicle include at least one of aeronautical, automotive, and marine vehicles.

21. The method of claim 19, wherein reproducing the series of points includes reproducing at least one of lines, cross hairs and text.

22. The method of claim 19, further comprising:
receiving a series of actual points corresponding to the surface; and
determining a best fit between the series of reference points and the series of actual points.
